(19) United States
(12) Patent Application Publication
(10) Pub. No.: US 2026/0342105 A1
(43) Pub. Date: Oct. 29, 2026

(54) CHARGING CONTROL METHOD FOR POWER CONVERTER, POWER CONVERTER, AND ELECTRIC DEVICE

(71) Applicant: ECOFLOW INC., Shenzhen (CN)

(72) Inventors: Wenxiang ZHANG, Shenzhen (CN); Lei WANG, Shenzhen (CN); Xi CHEN, Shenzhen (CN)

(21) Appl. No.: 19/637,908

(22) Filed: Apr. 2, 2026

(30) Foreign Application Priority Data
Apr. 24, 2025 (CN) 202510527317.9

(51) Int. Cl. H02J 7/35; H02J 3/32; H02J 3/38; H02J 7/00; H02J 7/14; H02J 7/90; H02J 101/24; H02J 101/28

(52) U.S. Cl. CPC H02J 7/35; H02J 3/32; H02J 3/381; H02J 7/1415; H02J 7/1469; H02J 7/855; H02J 7/933; H02J 2101/25; H02J 2101/28; H02J 2207/20

(57) ABSTRACT

A charging control method for a power converter is provided. The method includes: obtaining a first voltage value of a first end of each of DC/DC conversion circuits; controlling an alternating current input circuit to be in a precharging state, to precharge a first end of a target DC/DC conversion circuit; obtaining a second voltage value of the first end of each of the DC/DC conversion circuits after the precharging is completed, or obtaining a voltage change of the first end of each of the DC/DC conversion circuits during the precharging, to determine the target DC/DC conversion circuit from the plurality of parallel DC/DC conversion circuits.

### CROSS-REFERENCE TO RELATED APPLICATIONS

This application claims priority to Chinese Patent Application No. 202510527317.9, filed with the China National Intellectual Property Administration on Apr. 24, 2025 and entitled "CHARGING CONTROL METHOD FOR POWER CONVERTER, POWER CONVERTER, AND ELECTRIC DEVICE", which is incorporated herein by reference in its entirety.

### TECHNICAL FIELD

This application relates to the field of power electronic technologies, and in particular, to a charging control method for power converter, power converter, and an electric device.

### BACKGROUND

A power supply system using an energy storage device as a core includes: an energy storage battery, a photovoltaic panel, a maximum power point tracking (MPPT) circuit, and a grid-tied inverter, to provide a backup power supply to a home or achieve self-sufficient power supply by using green energy, thereby reducing power costs. Generally, a battery configured for home energy storage can supply power for a period of time after a loss of utility power. In a scenario with a prolonged loss of utility power, an alternating current power supply, for example, a generator (for example, a fuel-powered device such as a diesel engine, a gas engine, or a fuel generator) needs to be connected to supply power to a load when an energy storage battery is low.

In different energy storage systems, an alternating current power supply such as a generator has different connection manners. Therefore, how to accurately identify a connection channel of the alternating current power supply such as a generator also becomes difficult.

### SUMMARY

According to embodiments of this application, charging control method for a power converter, a power converter, and an electric device are provided.

An embodiment of this application provides a charging control method for a power converter, wherein the power converter comprises at least one alternating current input interface, at least one alternating current input circuit, a plurality of direct current input interfaces, and a plurality of parallel DC/DC conversion circuits; a first end of each of the DC/DC conversion circuits is configured to connect to the corresponding direct current input interface; each alternating current input interface is configured to connect to a first end of the corresponding alternating current input circuit; and the method comprises: obtaining a first voltage value of the first end of each of the DC/DC conversion circuits; controlling the alternating current input circuit to be in a precharging state, to precharge a first end of a DC/DC conversion circuit of the plurality of parallel DC/DC conversion circuits that is connected to a second end of the alternating current input circuit; obtaining a second voltage value of the first end of each of the DC/DC conversion circuits after the precharging is completed, or obtaining a voltage change of the first end of each of the DC/DC conversion circuits during the precharging; and determining at least one target DC/DC conversion circuit from the plurality of parallel DC/DC conversion circuits based on the first voltage value and the second voltage value, or determining at least one target DC/DC conversion circuit from the plurality of parallel DC/DC conversion circuits based on the voltage change.

An embodiment of this application further provides a power converter, where the power converter includes at least one alternating current input interface, at least one alternating current input circuit, a plurality of direct current input interfaces, and a plurality of parallel DC/DC conversion circuits; the power converter further includes a memory, a processor, and a computer program that is stored in the memory and that is capable of being run on the processor; a first end of each of the DC/DC conversion circuits is configured to connect to the corresponding direct current input interface; each alternating current input interface is configured to connect to a first end of the corresponding alternating current input circuit; and when executing the computer program, the processor implements the steps of the foregoing charging control method for a power converter.

An embodiment of this application further provides an electric device, including an energy storage module and the foregoing power converter.

An embodiment of this application further provides a computer program product. The computer program product, when run, causes the steps of the foregoing control method for a power converter to be performed.

Details of one or more embodiments of this application are provided in the following accompanying drawings and descriptions. Other features, objectives, and advantages of this application become obvious with reference to the specification, the accompanying drawings, and the claims.

### BRIEF DESCRIPTION OF THE DRAWINGS

To describe the technical solutions in embodiments or exemplary technologies of this application more clearly, the following briefly describes the accompanying drawings required for describing the embodiments or the exemplary technologies. Apparently, the accompanying drawings in the following description show merely some embodiments of this application, and a person of ordinary skill in the art may still derive drawings of other embodiments from these accompanying drawings without creative efforts.

FIG. 1 is a schematic diagram of a circuit of a power converter according to an embodiment of this application;

FIG. 2 is a flowchart of a charging control method for a power converter according to an embodiment of this application;

FIG. 3 is a flowchart of a charging control method for a power converter according to an embodiment of this application;

FIG. 4 is a flowchart of a charging control method for a power converter according to an embodiment of this application;

FIG. 5 is a schematic diagram of modules of a charging control apparatus for a power converter according to an embodiment of this application; and

FIG. 6 is a schematic diagram of a structure of a power converter according to an embodiment of this application.

### DETAILED DESCRIPTION

To make the technical problems to be resolved, technical solutions, and beneficial effects in this application clearer, the following further describes this application in detail with reference to the accompanying drawings and embodiments. It should be understood that the specific embodiments described herein are merely used to explain this application but are not intended to limit this application.

In addition, the terms "first" and "second" are merely intended for a purpose of description, and shall not be understood as an indication or implication of relative importance or implicit indication of the number of indicated technical features. Therefore, a feature limited by "first" or "second" may explicitly or implicitly include one or more features. In the descriptions of this application, "a plurality of" means two or more, unless otherwise definitely and specifically limited.

An energy storage system usually includes a power converter. The power converter may support a connection of a direct current power supply and an alternating current power supply, that is, a corresponding alternating current input interface and direct current input interface are usually disposed on the power converter. The alternating current power supply may supply power to the power converter through the alternating current input interface. The direct current power supply may supply power to the power converter through the direct current input interface. The power converter may further be connected to at least one of the grid, a load, and an energy storage device, to convert externally inputted power into corresponding electric energy to supply power to the load, supply power to the energy storage device when there is surplus electric energy, and feed surplus electric energy into the grid when grid feeding is allowed, thereby implementing management of electric energy.

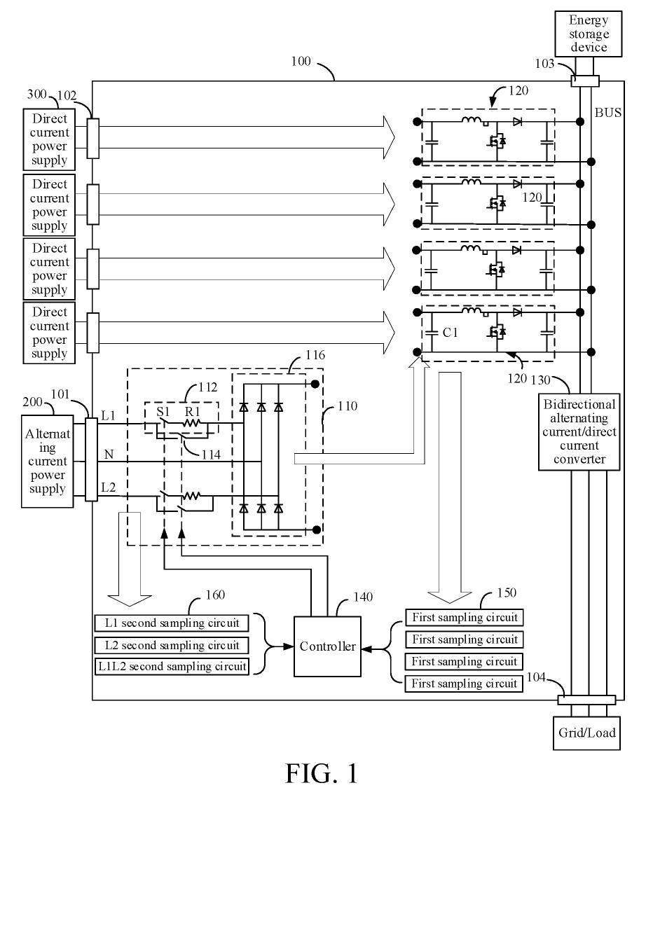

As shown in FIG. 1, a power converter 100 includes at least one alternating current input interface 101, at least one alternating current input circuit 110, a plurality of direct current input interfaces 102, and a plurality of parallel DC/DC conversion circuits 120. A first end of each of the DC/DC conversion circuits 120 is configured to connect to the corresponding direct current input interface 102. Each alternating current input interface 101 is configured to connect to a first end of the corresponding alternating current input circuit 110.

The alternating current input interface 101 is configured to connect to an alternating current power supply 200. The alternating current power supply 200 may be, for example, an alternating current power generation device such as a generator or a wind power generation apparatus. The generator may be a fuel-powered device such as a diesel engine, a gas engine, or a fuel generator. In this case, the corresponding alternating current input interface 101 is a generator input interface. The alternating current power supply 200 provides an alternating current to the alternating current input interface 101. The plurality of direct current input interfaces 102 may be configured to connect to a plurality of direct current power supplies 300 in a one-to-one correspondence. The direct current power supply 300 may be a photovoltaic assembly, a wind power generation assembly, or the like. In this case, the corresponding direct current input interface 102 is a photovoltaic assembly input interface, a wind power generation assembly input interface, or the like. The direct current power supply 300 may provide a direct current to the direct current input interface 102. A quantity of the plurality of direct current input interfaces 102 may be two, or more than two, for example, six or eight, and is specifically set depending on an actual requirement. Each of the direct current input interfaces 102 is configured to connect to a corresponding DC/DC conversion circuit 120.

The alternating current input circuit 110 includes a precharging circuit 112, a main charging switch 114, and a rectifier circuit 116. An input end of the rectifier circuit 116 is connected to the alternating current input interface 101 via the main charging switch 114. The precharging circuit 112 is parallel to the main charging switch 114. An output end of the rectifier circuit 116 constitutes a second end of an alternating current output circuit, and is configured to connect to a first end of a target DC/DC conversion circuit. The target DC/DC conversion circuit is a DC/DC conversion circuit of the plurality of parallel DC/DC conversion circuits 120 that is connected to a second end of the alternating current input circuit.

In some embodiments, the precharging circuit 112 includes a precharging switch S1 and a precharging resistor R1 that are connected in series. In this embodiment, the DC/DC conversion circuit 120 may be connected to the direct current input interface 102, so that the direct current power supply 300 supplies power through the direct current input interface 102, or may be connected to the alternating current input interface 101 through the alternating current input circuit 110. In this case, the alternating current power supply 200 supplies power through the alternating current input circuit 110. Therefore, a power adjustment strategy that needs to be executed by the DC/DC conversion circuit 120 needs to be determined based on whether the direct current power supply 300 or the alternating current power supply 200 is actually connected. Specifically, in the plurality of parallel DC/DC conversion circuits 120, when the direct current input interface 102 is connected to a photovoltaic assembly, the DC/DC conversion circuit 120 connected to the direct current input interface 102 is controlled in an MPPT control manner, that is, by using a maximum power point tracking strategy. In addition, the DC/DC conversion circuit 120 (referred to as the target DC/DC conversion circuit below) connected to the alternating current input interface 101 is controlled in a power factor correction (PFC) control manner, that is, by using a power factor correction adjustment strategy. Therefore, when the alternating current power supply 200 and the direct current power supply 300 both use a same DC/DC conversion circuit to implement power conversion, whether the current DC/DC conversion circuit is connected to the alternating current power supply 200 or the direct current power supply 300 needs to be determined, so that the DC/DC conversion circuit can execute a corresponding power adjustment strategy, to improve power conversion efficiency.

In some embodiments, a controllable switch may be disposed on a connection channel between the first end of each of the DC/DC conversion circuits 120 and the corresponding direct current input interface 102. When the controllable switch is in an open state, the controllable switch can be configured to disable a connection channel between the target DC/DC conversion circuit and the direct current input interface 102. In addition, a quantity of target DC/DC conversion circuits is determined through an actual circuit connection, and may be one or more. The DC/DC conversion circuit 120 includes a boost circuit, a buck circuit, or a boost-buck circuit.

In some embodiments, the power converter 100 further includes a direct current interface 103, an alternating current interface 104, a bidirectional alternating current/direct current converter 130, and a direct current bus BUS. A second end of each of the DC/DC conversion circuits 120, a direct current side of the bidirectional alternating current/direct current converter 130, and the direct current interface 103 are connected to the direct current bus BUS. An alternating current side of the bidirectional alternating current/direct current converter 130 is connected to an alternating current interface 104. The alternating current interface 104 is configured to connect to a grid and/or a load. The direct current interface 103 is configured to connect to an energy storage device. The energy storage device includes a battery module (not shown), or the energy storage device includes a bidirectional direct current converter and a battery module. The battery module is connected to the direct current interface 103 via the bidirectional direct current converter. The battery module includes one or more battery packs. The energy storage device may be built in or out of the power converter 100.

In some embodiments, a controller 140 is disposed on the power converter 100, and is configured to control operation of each circuit or switch. The controller 140 is, for example, a digital signal processor (DSP) or a field programmable gate array (FPGA) chip.

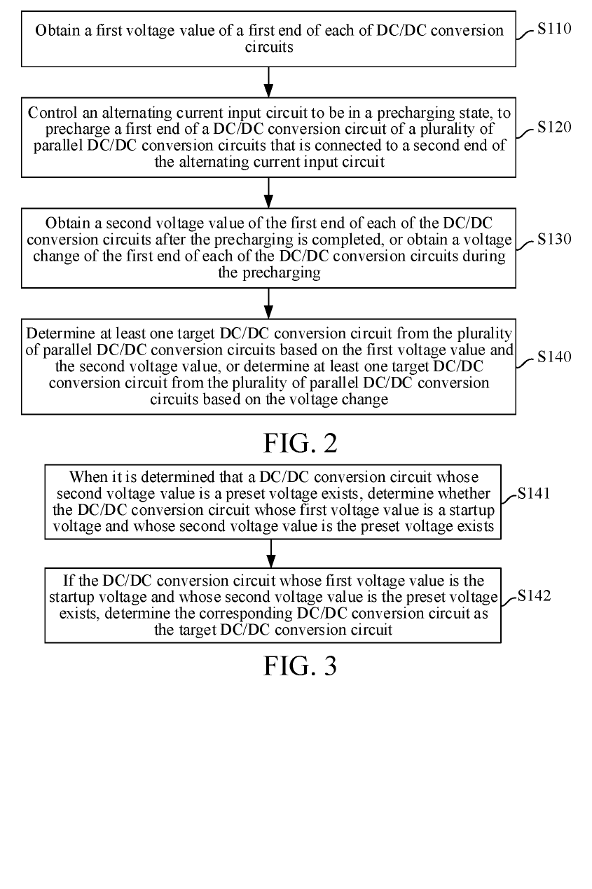

As shown in FIG. 2, in an embodiment of this application, a charging control method for a power converter is provided, including the following steps.

Step S110: Obtain a first voltage value of a first end of each of DC/DC conversion circuits.

A plurality of first sampling circuits 150 are disposed on a power converter 100. The plurality of first sampling circuits 150 are respectively connected to the first end of each of the DC/DC conversion circuits 120, and is configured to sample a voltage at the first end of each of the DC/DC conversion circuits 120, and output the voltage to the controller 140.

Step S120: Control an alternating current input circuit to be in a precharging state, to precharge a first end of a DC/DC conversion circuit of a plurality of parallel DC/DC conversion circuits that is connected to a second end of the alternating current input circuit.

A precharging switch S1 of a precharging circuit 112 is controlled to be turned on and a main charging switch 114 is turned off, so that when the alternating current input circuit 110 is connected to an alternating current power supply 200, the alternating current power supply 200 may precharge the first end of the DC/DC conversion circuit of a plurality of parallel DC/DC conversion circuits that is connected to a second end of the alternating current input circuit through the precharging circuit 112. The precharged DC/DC conversion circuit is also the target DC/DC conversion circuit to be ultimately determined. A precharging process mainly means charging an input capacitor C1 of the first end of the precharged DC/DC conversion circuit. The precharged DC/DC conversion circuit and the second end of the alternating current input circuit 110 may be connected through a power line, or may be switched on/off via a controllable switch.

Step S130: Obtain a second voltage value of the first end of each of the DC/DC conversion circuits after the precharging is completed, or obtain a voltage change of the first end of each of the DC/DC conversion circuits during the precharging.

Whether precharging the first end of the DC/DC conversion circuit is completed may be determined based on a value of a system charging identifier, or may be determined based on preset precharging duration. For example, the precharging lasts for 30 seconds. It may be understood that the preset precharging duration is set based on one or more of parameters such as an input power of the alternating current power supply 200 connected to the alternating current input interface 101, a capacity of the input capacitor C1 of the DC/DC conversion circuit, and a preset precharging voltage.

Step S140: Determine at least one target DC/DC conversion circuit from the plurality of parallel DC/DC conversion circuits based on the first voltage value and the second voltage value, or determine at least one target DC/DC conversion circuit from the plurality of parallel DC/DC conversion circuits based on the voltage change.

The target DC/DC conversion is a DC/DC conversion circuit of a plurality of parallel DC/DC conversion circuits that is connected to a second end of the alternating current input circuit.

It may be understood that, in the precharging state, if the target DC/DC conversion circuit exists, the second voltage value of the target DC/DC conversion circuit changes with a precharging voltage relative to the first voltage value.

For example, the second voltage value of the target DC/DC conversion circuit changes with an alternating current of the alternating current input interface 101 relative to the first voltage value. A first end of another DC/DC conversion circuit may be connected to a direct current, and the second voltage value is maintained within a particular voltage range relative to the first voltage value. If the DC/DC conversion circuit is connected to no direct current, the second voltage value and the first voltage value are both around 0 V. Therefore, a comparison may be performed between a first voltage value at the first end of each DC/DC conversion circuit 120 before precharging and a second voltage value after completion of precharging, so as to determine which DC/DC conversion circuit is the target DC/DC conversion circuit based on the first voltage value and the second voltage value at the first end of each DC/DC conversion circuit 120; alternatively, the target DC/DC conversion circuit may be determined based on the voltage change of the first end during the precharging, which is the target DC/DC conversion circuit.

In some embodiments, parameter information, for example, a waveform such as a voltage, a current, and a power, of an alternating current inputted by the alternating current power supply 200 to the alternating current input interface 101 may be obtained through communication with the alternating current power supply 200. The waveform also includes a parameter such as a change rate and a peak value. In some embodiments, at least one second sampling circuit 160 may further be disposed in the power converter 100, and is connected to the alternating current input interface 101. The second sampling circuit 160 is configured to sample a voltage of the alternating current input interface 101, and output the voltage to the controller 140, to determine the parameter information of the alternating current of the alternating current input interface 101.

The power converter 100 shown in FIG. 1 includes four direct current input interfaces 102, one alternating current input interface 101, four DC/DC conversion circuits 120, four first sampling circuits 150, and three second sampling circuits 160. First ends of the four DC/DC conversion circuits 120 are respectively connected to the four first sampling circuits 150 in a one-to-one correspondence, and the three second sampling circuits 160 are respectively connected to three-phase terminals L1, L2, and N of the alternating current input interface 101 in a one-to-one correspondence. In another example, a quantity of DC/DC conversion circuits 120 and a quantity of first sampling circuits 150 may be set based on an actual quantity of DC/DC conversion circuits 120, and are not limited to the foregoing embodiment. The second sampling circuit 160 is mainly configured to sample an L1 phase voltage, an L2 phase voltage, and the line-to-line voltage between L1 and L2.

In some embodiments, step S140 includes:
Step S140A: Determine, as the target DC/DC conversion circuit, a DC/DC conversion circuit 120 whose first voltage value is a startup voltage and whose second voltage value is a preset voltage, where the startup voltage is less than the preset voltage.

When the connected alternating current input circuit 110 is not in the precharging state or a charging state, the target DC/DC conversion circuit is in an open circuit state. In this case, the target DC/DC conversion circuit has no corresponding power supply input. Therefore, a voltage at the first end of the target DC/DC conversion circuit is 0, and the startup voltage is required to be 0. In another embodiment, the voltage at the first end of the target DC/DC conversion circuit falling within a particular deviation range may alternatively be considered as falling within a startup voltage range. It may be understood that the startup voltage is a voltage value of the target DC/DC conversion circuit before the precharging in step S120 is performed, and a specific value should be determined as required.

After the first end of the target DC/DC conversion circuit is precharged by the alternating current power supply 200, a voltage of the input capacitor C1 of the first end of the target DC/DC conversion circuit may reach a peak value of an alternating current voltage outputted by the alternating current power supply 200. That is, the preset voltage is the peak value of the alternating current voltage of the alternating current power supply 200.

When the DC/DC conversion circuit 120 is connected to the direct current input interface 102, because a direct current voltage inputted by the direct current input interface 102 falls within a stable voltage range, a voltage change generated at the first end of the corresponding DC/DC conversion circuit 120 is obviously different from a voltage change generated by the alternating current input circuit 110.

Therefore, in the precharging state, when the voltage at the first end of the DC/DC conversion circuit 120 is charged from the startup voltage to the peak value of the alternating current voltage outputted by the alternating current power supply 200, it may be determined that the DC/DC conversion circuit 120 is the target DC/DC conversion circuit.

Based on the foregoing analysis, in some embodiments, step S140 may alternatively include: step S140B: Determine, as the target DC/DC conversion circuit, a DC/DC conversion circuit 120 whose voltage change is gradually increasing from the startup voltage to the preset voltage.

In some embodiments, step S140 includes: step S140C: Determine, as the target DC/DC conversion circuit, a DC/DC conversion circuit 120 whose voltage change rate falls within a preset change rate range, where the voltage change rate is determined based on the voltage change.

For example, the voltage change is gradually increasing from the startup voltage to the preset voltage, and the voltage change rate may be determined based on the change/waveform.

It may be understood that the preset change rate may be set based on the parameter information of the alternating current of the alternating current input interface 101. For example, an entire precharging operation process lasts for 30 seconds. Therefore, the preset change rate is required to fit a voltage waveform of the alternating current provided by the alternating current input interface 101 during the precharging, or a voltage waveform obtained after the alternating current is rectified by the alternating current input circuit 110.

In some embodiments, after the first voltage value and the second voltage value of the first end of each of the DC/DC conversion circuits 120 are obtained, the target DC/DC conversion circuit may be directly determined through comparison one by one.

As shown in FIG. 3, in some embodiments, step S140 includes the following steps.

Step S141: When it is determined that a DC/DC conversion circuit whose second voltage value is a preset voltage exists, determine whether the DC/DC conversion circuit whose first voltage value is a startup voltage and whose second voltage value is the preset voltage exists.

Step S142: If the DC/DC conversion circuit whose first voltage value is the startup voltage and whose second voltage value is the preset voltage exists, determine the corresponding DC/DC conversion circuit as the target DC/DC conversion circuit.

This embodiment is slightly different from the foregoing embodiment. First, it is determined whether the DC/DC conversion circuit 120 whose second voltage value is the preset voltage exists. If such a DC/DC conversion circuit 120 exists, the first voltage value at the first end of each of the DC/DC conversion circuits 120 before precharging is obtained. Then, the target DC/DC conversion circuit is determined based on whether the DC/DC conversion circuit 120 whose first voltage value is the startup voltage and whose second voltage value is the preset voltage exists.

In some embodiments, in a case in which it is determined in step S141 that no DC/DC conversion circuit 120 whose second voltage value is the preset voltage exists, it may be directly determined that there is no target DC/DC conversion circuit.

When there is no target DC/DC conversion circuit, a precharging failure may be caused due to an open circuit fault in the alternating current input circuit 110, or the DC/DC conversion circuit 120 fails. In this case, when it is determined that no target DC/DC conversion circuit exists, the alternating current input circuit 110 needs to be controlled to be in an open circuit state, that is, both the precharging switch S1 and the main charging switch 114 are controlled to be in turned-off state, to prevent the alternating current input circuit 110 from supplying power to the corresponding DC/DC conversion circuit 120.

In some embodiments, step S120 includes:
controlling the alternating current input circuit 110 to be in a precharging state within first preset duration, to complete precharging the first end of the target DC/DC conversion circuit.

During the precharging, the main charging switch 114 is not turned on yet, and an alternating current provided by the alternating current power supply 200 (for example, a generator) and the like precharges a connected DC/DC conversion circuit 120 through the precharging circuit 112. A precharging resistor R1 is disposed on the precharging circuit 112 to limit a current, to ensure that the first end of the target DC/DC conversion circuit can be precharged with a relatively low current in a precharging stage until the precharging is completed. Therefore, it can be ensured that the target DC/DC conversion circuit is not directly surged by a large current that is turned on by the main charging switch 114, thereby ensuring device security. Therefore, in a case in which device security is ensured, after the alternating current input interface 101 is connected to the alternating current power supply 200 and before the main charging switch 114 is turned on, the alternating current input circuit 110 may be first controlled to be in the precharging state for a period of time, for example, tens of seconds to several minutes, to complete the precharging. The first preset duration may be determined based on a value of a capacitance at an input end of the DC/DC conversion circuit 120, a preset precharging voltage, an output capability of the alternating current power supply 200, and the like, and is not strictly limited to a specific value.

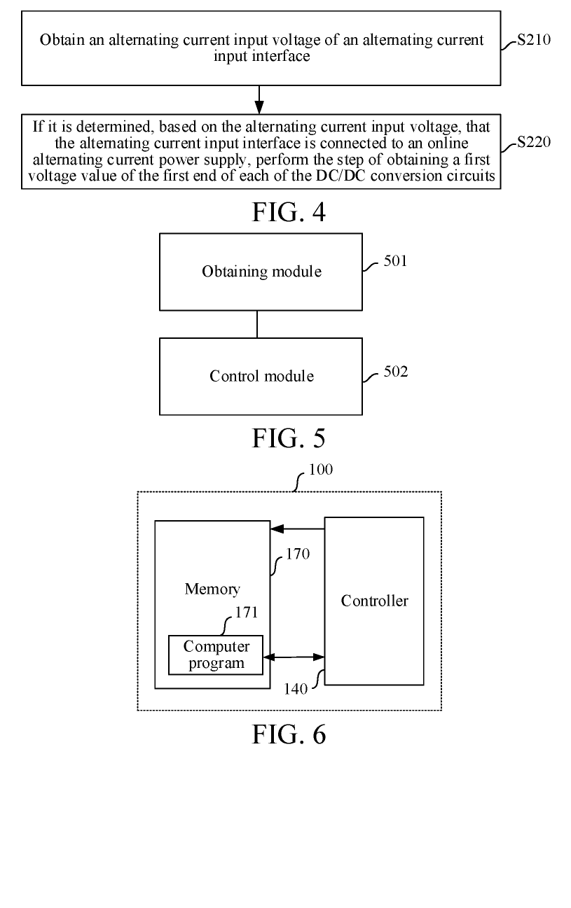

As shown in FIG. 4, in some embodiments, before step S110, the method further includes:
Step S210: Obtain an alternating current input voltage of the alternating current input interface.

As described above, the alternating current input voltage may be detected through the second sampling circuit 160. In another embodiment, the alternating current input voltage may alternatively be obtained through communication with the alternating current power supply 200.

Step S220: If it is determined, based on the alternating current input voltage, that the alternating current input interface is connected to an online alternating current power supply, perform the step of obtaining a first voltage value of the first end of each of the DC/DC conversion circuits.

For example, whether the alternating current input interface 101 is connected to the online alternating current power supply 200 may be determined based on a value of the alternating current input voltage and the like. Step S110 and a subsequent step are performed only when it is determined that the online alternating current power supply 200 is connected. If it is determined that the alternating current power supply 200 is not connected or an offline alternating current power supply 200 is connected, the foregoing step does not need to be started, that is, a connection channel of the alternating current power supply 200 does not need to be determined. Being offline means a state in which the alternating current power supply 200 is connected but has no voltage or no power output, or a state in which a voltage output/power output is relatively small and consequently, the output is equivalent to no output.

For example, when it is determined that the alternating current power supply 200 is connected, if a valid value of the alternating current input voltage is less than a first threshold, it is determined that the alternating current power supply 200 is offline, that is, no alternating current is outputted. The first threshold may be set to 50 V or another value. Optionally, when the valid value of the alternating current input voltage is less than the first threshold and lasts for first duration, for example, tens of milliseconds to several seconds, it may further be determined that the alternating current power supply 200 is offline. Optionally, in a case in which it is determined that the alternating current power supply 200 is offline, the alternating current input circuit 110 is disconnected, for example, both the precharging switch S1 and the main charging switch 114 are controlled to be turned off. In some embodiments, when the connected alternating current power supply 200 is in an offline state, step S110 and a subsequent step are not performed, that is, none of the DC/DC conversion circuits 120 determine the connection channel of the alternating current power supply 200. In some embodiments, the DC/DC conversion circuit 120 may determine a connection status of a direct current power supply 300 (for example, PV) when determining that no alternating current power supply 200 is connected or that the connected alternating current power supply 200 is offline.

For example, if the valid value of the alternating current input voltage is greater than a second threshold, it is determined that the alternating current power supply 200 is online, that is, an alternating current is outputted. The second threshold is greater than the first threshold. For example, the second threshold may be set to 80 V or the like. Optionally, when the valid value of the alternating current input voltage is greater than the second threshold and lasts for second duration, for example, tens of milliseconds to several seconds, it may further be determined that the alternating current power supply 200 is online. Optionally, in a case in which it is determined that the alternating current power supply 200 is online, step S110 and a subsequent step are further performed, that is, a channel connected by the alternating current power supply 200 is determined. In some embodiments, when it is determined that the alternating current power supply 200 is connected and is in an online state, a charging completion flag may be reset to a first identifier, to ensure that a charging process can be subsequently performed. The charging completion flag may have a first identifier, a second identifier, and the like. When the charging completion flag is set to the first identifier, it is identified that the charging process can be performed. When the charging completion flag is set to the second identifier, it is identified that the charging process cannot be subsequently performed. For example, the charging completion flag may be set to the second identifier when charging is not required or a circuit fault exists.

In some embodiments, before whether the alternating current power supply 200 is online (that is, there is an alternating current input meeting a requirement of the power converter 100) is determined, whether the alternating current power supply 200 is connected to the alternating current input interface 101 may further be determined first. For example, a connection detection circuit of the alternating current power supply 200 is further disposed on the alternating current input interface 101 of the power converter 100. The connection detection circuit of the alternating current power supply 200 is configured to interact with the alternating current power supply 200, to determine that the alternating current power supply 200 is connected to the alternating current input interface 101.

In some embodiments, the charging control method for a power converter further includes:
if it is determined that at least one target DC/DC conversion circuit exists, controlling the alternating current input circuit 110 to switch to a charging state, so that an alternating current power supply 200 inputted through an alternating current input interface 101 charges the target DC/DC conversion circuit through the alternating current input circuit 110.

Specifically, the alternating current input circuit 110 is controlled to switch to the charging state, that is, the precharging switch S1 is controlled to be turned off and the main charging switch 114 to be turned on, so that the alternating current inputted by the alternating current power supply 200 supplies power to the target DC/DC conversion circuit after passing through the main charging switch 114 and the rectifier circuit 116, to meet a power-consuming requirement of a user. In this process, the target DC/DC conversion circuit is controlled to operate in a PFC mode, that is, a PFC power adjustment strategy is executed, to adapt to a power adjustment requirement of the alternating current power supply 200.

Optionally, in a process of controlling the precharging switch S1 to be turned off and the main charging switch 114 to be turned on, after the command of controlling the main charging switch 114 to be turned on is sent, a delay may be made to ensure that the command of controlling the precharging switch S1 to be turned off is sent after the main charging switch 114 is turned on, to ensure that the main charging switch 114 is in a turned-on state when the precharging switch S1 is turned off, thereby avoiding a power-off problem in a switching process.

In some embodiments, the foregoing steps of connection detection and online detection performed on the alternating current power supply 200 are periodically and repeatedly performed, to ensure that a change in a status of the connected alternating current power supply 200 can be found in time, for example, switching from online to offline, switching from offline to online, switching from connected to not connected, or switching from not connected to connected, to ensure that a status of the target DC/DC conversion circuit can match the status of the connected alternating current power supply 200.

In some embodiments, the charging control method for a power converter further includes:
if it is determined that at least one target DC/DC conversion circuit exists, disabling a direct current input interface 102 corresponding to the target DC/DC conversion circuit, to prevent the target DC/DC conversion circuit from connecting to both the alternating current power supply 200 and the direct current power supply 300.

In some embodiments, the charging control method for a power converter further includes:
if it is determined that no target DC/DC conversion circuit exists, controlling the alternating current input circuit 110 to be in an open circuit state, that is, controlling both the main charging switch 114 and the precharging switch S1 to be disconnected; and if it is determined that no target DC/DC conversion circuit exists, controlling the alternating current input circuit 110 to be in an open circuit state. That is, all the DC/DC conversion circuits 120 are connected to the direct current input interface 102 by default. When it is determined that there is no target DC/DC conversion circuit currently, it indicates that no online alternating current power supply 200 is currently connected. In this case, to avoid a problem that sudden power supply of the alternating current power supply 200 causes a current surge and further damage to a circuit, the alternating current input circuit 110 needs to be in an open circuit state.

In some embodiments, the charging control method for a power converter further includes:
controlling the target DC/DC conversion circuit to execute a first power adjustment strategy, and controlling a non-target DC/DC conversion circuit to execute a second power adjustment strategy, where the first power adjustment strategy matches the alternating current power supply 200 connected to the alternating current input interface 101. The second power adjustment strategy matches the direct current power supply 300 connected to the direct current input interface 102.

For example, the first power adjustment strategy is a PFC control manner, to increase a power factor. For example, the second power adjustment strategy is an MPPT control manner. When the direct current power supply 300 and the alternating current power supply 200 share a DC/DC conversion circuit, a corresponding power adjustment strategy is adjusted based on a specific connected power supply type, so that conversion efficiency of the DC/DC conversion circuit can be increased.

As shown in FIGS. 1 and FIG. 5, an embodiment of this application further provides a charging control apparatus for a power converter, including:
an obtaining module 501, configured to obtain a first voltage value of a first end of each of DC/DC conversion circuits 120; and
a control module 502, configured to control an alternating current input circuit 110 to be in a precharging state, to precharge a first end of a DC/DC conversion circuit of a plurality of parallel DC/DC conversion circuits 120 that is connected to a second end of the alternating current input circuit 110.

The obtaining module 501 is further configured to obtain a second voltage value of the first end of each of the DC/DC conversion circuits 120 after the precharging is completed, or obtain a voltage change of the first end of each of the DC/DC conversion circuits 120 during the precharging.

The control module 502 is further configured to determine at least one target DC/DC conversion circuit from the plurality of parallel DC/DC conversion circuits 120 based on at least one of the first voltage value, the second voltage value, and a voltage change.

In some embodiments, for descriptions of specific implementations and related beneficial effects of the charging control apparatus for a power converter, refer to the descriptions of the specific embodiments of the foregoing charging control method for a power converter, and details are not described herein again.

As shown in FIGS. 1 and FIG. 6, an embodiment of this application further provides a power converter 100. The power converter 100 includes at least one alternating current input interface 101, at least one alternating current input circuit 110, a plurality of direct current input interfaces 102, and a plurality of parallel DC/DC conversion circuits 120. The power converter 100 further includes a memory 170, a controller 140, and a computer program 171 that is stored in the memory 170 and that can be run on the processor. A first end of each of the DC/DC conversion circuits 120 is configured to connect to the corresponding direct current input interface 102. Each alternating current input interface 101 is configured to connect to a first end of the corresponding alternating current input circuit 110. When executing the computer program, the controller 140 implements the steps of the charging control method for a power converter in any one of the foregoing embodiments.

The controller 140 may be a central processing unit (CPU), and the controller 140 may further be another general-purpose controller 140, a digital signal controller 140 (DSP), an application-specific integrated circuit (ASIC), a field-programmable gate array (FPGA), another programmable logic device, a discrete gate or transistor logic device, a discrete hardware component, or the like. The general-purpose controller may be a microcontroller or may be any conventional controller.

In some embodiments, the memory 170 may be an internal storage unit of the power converter 100, for example, a hard disk or a memory of an electric device or an energy storage device. In some other embodiments, the memory 170 may alternatively be an external storage device of the power converter 100, for example, a plug-in hard disk, a smart media card (SMC), a secure digital (SD) card, or a flash card that is equipped on an electric device or an energy storage device. Further, the memory 170 may further include both an internal storage unit and an external storage device of the power converter 100. The memory 170 is configured to store an operating system, an application program, a boot loader, data, another program, and the like. The memory 170 may further be configured to temporarily store data that has been outputted or to be outputted. In some embodiments, the at least one alternating current input interface 101 includes at least one generator input interface. The plurality of direct current input interfaces 102 include at least two photovoltaic assembly input interfaces.

An embodiment of this application further provides an electric device, including an energy storage module and the power converter 100 in any one of the foregoing embodiments. It may be understood that the electric device may be an independent power converter 100, or may be a power supply apparatus having an energy storage module. The energy storage module may be built in or out of the electric device. The electric device and the energy storage module may be integrated, or may be split. The energy storage module may alternatively be the foregoing energy storage device.

In some embodiments, the at least one alternating current input interface 101 includes at least one generator input interface. The plurality of direct current input interfaces 102 include at least two photovoltaic assembly input interfaces.

An embodiment of this application provides a computer program product. The computer program product, when run on a computer, causes the computer to perform the steps in the foregoing method embodiments.

The foregoing embodiments are merely intended for describing the technical solutions of this application other than limiting this application. Although this application is described in detail with reference to the foregoing embodiments, a person of ordinary skill in the art should understand that they may still make modifications to the technical solutions described in the foregoing embodiments or make equivalent replacements to some technical features thereof. The modifications and replacements do not cause the essence of the corresponding technical solutions to depart from the spirit and scope of the technical solutions of the embodiments of this application, and shall all fall within the protection scope of this application.

What is claimed is:

1. A charging control method for a power converter, wherein the power converter comprises at least one alternating current input interface, at least one alternating current input circuit, a plurality of direct current input interfaces, and a plurality of parallel DC/DC conversion circuits; a first end of each of the DC/DC conversion circuits is configured to connect to the corresponding direct current input interface; each alternating current input interface is configured to connect to a first end of the corresponding alternating current input circuit; and the method comprises:
obtaining a first voltage value of the first end of each of the DC/DC conversion circuits;
controlling the alternating current input circuit to be in a precharging state, to precharge a first end of a DC/DC conversion circuit of the plurality of parallel DC/DC conversion circuits that is connected to a second end of the alternating current input circuit;
obtaining a second voltage value of the first end of each of the DC/DC conversion circuits after the precharging is completed, or obtaining a voltage change of the first end of each of the DC/DC conversion circuits during the precharging; and
determining at least one target DC/DC conversion circuit from the plurality of parallel DC/DC conversion circuits based on the first voltage value and the second voltage value, or determining at least one target DC/DC conversion circuit from the plurality of parallel DC/DC conversion circuits based on the voltage change.

2. The method according to claim 1, wherein the determining at least one target DC/DC conversion circuit from the plurality of parallel DC/DC conversion circuits based on the first voltage value and the second voltage value, or determining at least one target DC/DC conversion circuit from the plurality of parallel DC/DC conversion circuits based on the voltage change comprises any one of the following:
determining, as the target DC/DC conversion circuit, a DC/DC conversion circuit whose first voltage value is a startup voltage and whose second voltage value is a preset voltage, wherein the startup voltage is less than the preset voltage;
determining, as the target DC/DC conversion circuit, a DC/DC conversion circuit whose voltage change is gradually increasing from the startup voltage to the preset voltage; and
determining, as the target DC/DC conversion circuit, a DC/DC conversion circuit whose voltage change rate falls within a preset change rate range, wherein the voltage change rate is determined based on the voltage change.

3. The method according to claim 1, wherein the determining at least one target DC/DC conversion circuit from the plurality of parallel DC/DC conversion circuits based on the first voltage value and the second voltage value, or determining at least one target DC/DC conversion circuit from the plurality of parallel DC/DC conversion circuits based on the voltage change comprises:
when it is determined that a DC/DC conversion circuit whose second voltage value is a preset voltage exists, determining whether the DC/DC conversion circuit whose first voltage value is a startup voltage and whose second voltage value is the preset voltage exists; or
if the DC/DC conversion circuit whose first voltage value is the startup voltage and whose second voltage value is the preset voltage exists, determining the corresponding DC/DC conversion circuit as the target DC/DC conversion circuit.

4. The method according to claim 1, wherein the controlling the alternating current input circuit to be in a precharging state, to precharge a first end of a target DC/DC conversion circuit comprises:
controlling the alternating current input circuit to be in the precharging state within first preset duration, to complete precharging the first end of the target DC/DC conversion circuit.

5. The method according to claim 1, before the obtaining a first voltage value of the first end of each of the DC/DC conversion circuits, further comprising:
obtaining an alternating current input voltage of the alternating current input interface; and
if it is determined, based on the alternating current input voltage, that the alternating current input interface is connected to an online alternating current power supply, performing the step of obtaining a first voltage value of the first end of each of the DC/DC conversion circuits.

6. The method according to claim 1, wherein the method further comprises:
if it is determined that at least one target DC/DC conversion circuit exists, controlling the alternating current input circuit to switch to a charging state, so that an alternating current power supply inputted through the alternating current input interface charges the target DC/DC conversion circuit through the alternating current input circuit.

7. The method according to claim 1, wherein the method further comprises:
if it is determined that at least one target DC/DC conversion circuit exists, disabling the direct current input interface corresponding to the target DC/DC conversion circuit.

8. The method according to claim 1, wherein the method further comprises:
if it is determined that no target DC/DC conversion circuit exists, controlling the alternating current input circuit to be in an open circuit state.

9. The method according to claim 1, wherein the method further comprises:
controlling the target DC/DC conversion circuit to execute a first power adjustment strategy; and
controlling a non-target DC/DC conversion circuit to execute a second power adjustment strategy, wherein
the first power adjustment strategy matches an alternating current power supply connected to the alternating current input interface; and the second power adjustment strategy matches a direct current power supply connected to the direct current input interface.

10. The method according to claim 9, wherein the first power adjustment strategy is a power factor correction adjustment strategy; and the second power adjustment strategy is a maximum power point tracking strategy.

11. A power converter, wherein the power converter comprises at least one alternating current input interface, at least one alternating current input circuit, a plurality of direct current input interfaces, and a plurality of parallel DC/DC conversion circuits; the power converter further comprises a memory, a processor, and a computer program stored in the memory and capable of being run on the processor; a first end of each of the DC/DC conversion circuits is configured to connect to the corresponding direct current input interface; each alternating current input interface is configured to connect to a first end of the corresponding alternating current input circuit; and when executing the computer program, the processor implements the steps of the charging control method for a power converter according to claim 1.

12. The power converter according to claim 11, wherein the at least one alternating current input interface comprises at least one generator input interface.

13. The power converter according to claim 11, wherein the plurality of direct current input interfaces comprise at least two photovoltaic assembly input interfaces.

14. An electric device, comprising an energy storage module and the power converter according to claim 11.

15. The electric device according to claim 14, wherein the at least one alternating current input interface comprises at least one generator input interface.

16. The electric device according to claim 14, wherein the plurality of direct current input interfaces comprise at least two photovoltaic assembly input interfaces.
